(19) United States
(12) Patent Application Publication
(10) Pub. No.: US 2013/0097934 A1
(43) Pub. Date: Apr. 25, 2013

(54) UNIVERSAL DOOR FRAMES

(71) Applicant: Gregory Alan Cook, Scottsdale, AZ (US)

(72) Inventor: Gregory Alan Cook, Scottsdale, AZ (US)

(73) Assignee: DW ACQUISITION, INC., Scottsdale, AZ (US)

(21) Appl. No.: 13/279,008

(22) Filed: Oct. 21, 2011

(51) Int. Cl. E06B 3/46; B22C 9/20; E05D 15/12

(52) U.S. Cl. 49/404; 16/96 R; 164/271

(57) ABSTRACT

The present disclosure includes a system and article of manufacture comprising a universal sliding door frame. The frame may comprise a first track having a first interface and a second track having a second interface. The second interface may slidably couple to the first interface. In addition, the second interface may be orthogonally inseparable from the first interface. In an embodiment, the frame may comprise a spacer that separates the first track from the second track and slidably couples to the first track via the first interface and the second track via second interface. The spacer may, in addition, be orthogonally inseparable from the first and/or second tracks.

### BACKGROUND

1. Field

The present disclosure generally relates to doors, door frames, door mounting systems, door security systems, and the like.

2. Related Art

Doors are a fundamental component in the construction and renovation of all habitable structures, and are offered in a wide variety of shapes, sizes, and configurations. For example, one type of door, the single sliding door, has become a mainstay portal to the backyard and/or patio of many a common residence, while more complex groupings of sliding doors are often employed in the construction of other, more lavish, residences. Similarly, another type of door, the bi-fold door, is popularly “hung,” or mounted, in a variety of spaces. These, and other doors, may vary in size and shape according to one or more standard door thicknesses, doorway sizes, climate, manufacturer, and the like. For instance, sliding doors may be manufactured to insulate against inclement weather and/or to fit into a variety of doorways and/or door frames. Likewise, bi-fold doors may be manufactured with a variety of locking mechanisms (e.g., internal gears, push bolts, etc.)

For each shape, size, and configuration of door, a corresponding door frame must be manufactured to mount the door. Commonly, each of a particular brand and style of door must be mated with a respective frame. That is, a door may only be compatible with a particular brand and style of door frame. Thus, it is often necessary to purchase a door together with its associated frame. This incompatibility between doors and door frames engenders a corresponding increase in the price of doors, in large part due to the variety of non-uniform processes and equipment that are required for the manufacture of each door-frame pair.

With further regard to sliding doors, an additional drawback exists, in that doors of this type are typically mounted to the exteriors of structures. This mounting configuration makes the mounting brackets and/or securing bolts accessible from the exterior of the structure to which the door is secured. That is, this configuration is easily exploited by an individual with bad intentions (e.g., a thief). Indeed, all that is required in order to break and enter such a structure is that the ill intentioned individual remove the securing bolt or bolts, which, again, are commonly accessible from the exterior of the structure.

Many doors, including sliding doors, are further beset by an inability to effectively and/or more completely insulate against the outdoors. That is, many doors fail to seal tightly against the door frame to which they are mounted. Further, although it is not uncommon for a door frame and/or a door to include weather stripping, the stripping is typically installed in a manner that frictionally impedes the motion of the door against the door frame.

It would be advantageous, therefore, to manufacture a universal door frame capable of receiving and/or mounting a variety of doors. For instance, it would be advantageous to manufacture a universal sliding door frame capable of receiving a plurality types of sliding doors. Likewise, it would be advantageous to manufacture a universal bi-fold door frame capable of receiving a variety of types of bi-fold doors. In addition, it would be advantageous to manufacture a door, particularly a sliding door, capable of resisting break in attempts. It would also be advantageous to manufacture a door and/or door frame better suited to the exclusion of the climate to which it is set as a barrier and/or capable of moving freely in the presence of insulation and/or weather stripping.

### SUMMARY

The present disclosure includes a system and article of manufacture comprising a universal sliding door frame. The frame may comprise a first track having a first interface and a second track having a second interface. The second interface may slidably couple to the first interface. In addition, the second interface may be orthogonally inseparable from the first interface. In an embodiment, the frame may comprise a spacer that separates the first track from the second track and slidably couples to the first track via the first interface and the second track via second interface. The spacer may, in addition, be orthogonally inseparable from the first and/or second tracks. With respect to the shape of each of the first and second interfaces, these may comprise a groove and/or a tongue. In an embodiment, the frame may enhance the security of a particular structure, and this may be accomplished by way of a follower that secures an interior portion of a door to an interior portion of a structure. The frame may additionally comprise an insulating material, which may be compressed by the weight of a door mounted on the frame when the door is lowered within the frame. When a door is raised within the frame, however, the insulating material may not frictionally impede the door. The frame may include a thermal break.

The present disclosure further includes a system and article of manufacture comprising a universal bi-fold door frame. A universal bi-fold door frame may include a first channel for receiving a first lock and a second channel for receiving a second lock. The first and/or second locks may comprise push bolts and/or internal gear locks. The first channel and second channels may comprise a track as well as a header.

The present disclosure further includes a system and article of manufacture comprising a die set for casting a universal sliding door frame. A die set may comprise a first die for casting a first track having a first interface, and a second die for casting a second track having a second interface. The first interface and second interface may slidably couple to one another. In addition, these interfaces may be orthogonally inseparable from one another. In an embodiment, a die set may, in addition, comprise a third die for casting a spacer that separates the first track from the second track.

The present disclosure further includes a system and article of manufacture comprising a universal sliding door frame kit. The kit may comprise, in an embodiment, a first track having a first track interface, and a second track having a second track interface. The kit may further include a first header having a first header interface and a second header having a second header interface. As described above, the first track interface may slidably couple to the second track interface. Likewise, the first header interface may slidably couple to the second header interface. In an embodiment, both the tracks as well as the headers may be orthogonally inseparable. Further, the kit may include a spacer that slidably couples to the first track interface and the second track interface as well as a spacer that slidably couples to the first header interface and the second header interface. As described above, an interface may comprise a tongue or a groove, an insulating material that may be compressed when a door is in a lowered position, and a thermal break.

### BRIEF DESCRIPTION OF THE DRAWINGS

The features and advantages of the present disclosure will become more apparent from the detailed description set forth below when taken in conjunction with the drawings. The left-most digit of a reference number identifies the drawing in which the reference number first appears.

FIG. 1 shows a cross-sectional view of an exemplary track.

FIG. 2 shows a cross-sectional view of an exemplary base fitting.

FIG. 3 shows a cross-sectional view of an exemplary base fitting riding on a track.

FIG. 4 shows a cross-sectional view of an exemplary plurality of slidably coupled and orthogonally inseparable tracks.

FIG. 5 shows a cross-sectional view of an exemplary spacer.

FIG. 6 shows a cross-sectional view of an exemplary plurality of slidably coupled and orthogonally inseparable tracks coupled by a spacer.

FIG. 7 shows a cross-sectional view of an exemplary header.

FIG. 8 shows a cross-sectional view of an exemplary plurality of slidably coupled and orthogonally inseparable headers.

FIG. 9 shows a cross-sectional view of an exemplary header for use with a lift and slide system.

FIG. 10 shows a cross-sectional view of an exemplary header for use with a lift and slide system as well as a panel associated with a lift and slide system in a raised position.

FIG. 11 shows a cross-sectional view of an exemplary security system for a universal door frame.

FIG. 12 shows a cross-sectional view of an exemplary track associated with a bi-fold system.

FIG. 13 shows a cross-sectional view of an exemplary header associated with a bi-fold system.

### DETAILED DESCRIPTION

The detailed description of exemplary embodiments herein makes reference to the accompanying drawings, which show the exemplary embodiments by way of illustration and their best mode. While these exemplary embodiments are described in sufficient detail to enable those skilled in the art to practice the disclosure, it should be understood that other embodiments may be realized and that logical and mechanical changes may be made without departing from the spirit and scope of the disclosure. Thus, the detailed description herein is presented for purposes of illustration only and not of limitation. Furthermore, any reference to singular includes plural embodiments, and any reference to more than one component may include a singular embodiment.

While specific embodiments of the present invention will be described in greater detail below, in general, an embodiment of the present invention comprises a universal door frame. The door frame may be assembled according to a door or panel size, type, and/or according to a number of doors or panels; and, in this way, a universal door frame may accommodate or support a variety of panel sizes, panel types, and/or numbers of panels. For example, in an embodiment, a universal door frame may accommodate a variety of sizes, types and/or numbers of sliding panels. Likewise, in an embodiment, a universal door frame may accommodate a variety of sizes, types, and/or numbers of bi-fold doors.

To this end, a universal door frame may comprise a plurality of tracks (“tracks”), each having one or more interfaces. Likewise, a universal door frame may comprise a plurality of headers, each, as well, having one or more interfaces. Each track and/or header may slidably couple, via the one or more interfaces, to one or more other tracks and/or headers, respectively. Thus, for example, where a universal door frame is configured to accommodate a plurality of sliding doors, a plurality of tracks may be slidably coupled to support the appropriate number of sliding doors. Likewise, a plurality of headers may be slidably coupled to guide and stabilize the number of sliding doors. That is, and in other words, a particular number of tracks and/or headers may be slidably coupled to accommodate a selected number of sliding doors. Likewise, where a particular size and/or type of door are required, a compatible group of tracks and/or headers may be selected to accommodate the door size and/or type. Thus, the frame itself may be applied universally to any number, size, and/or type of door(s).

Further, although tracks, as well as headers, may slidably couple to and decouple from one another, each may, in addition, couple such that they are orthogonally inseparable from others of their kind (e.g., tracks to tracks and headers to headers). For example, a pair of “orthogonally inseparable” tracks may comprise a pair of tracks that cannot be separated (short of damaging the tracks, at least) in a direction that is orthogonal or perpendicular to the surfaces or edges defining the intersection of the tracks. In other words, an orthogonally inseparable pair of tracks may be coupled and decoupled along a first axis, but may not be coupled and decoupled along any other axis. And again, the same description may be applied to headers.

Orthogonally inseparable tracks and headers may be advantageous, in an embodiment, in that they may resist separation. That is, a pair of orthogonally inseparable tracks and/or headers may tend not to decouple or shear apart, particularly in a direction that would tend to derail or induce a slant or angle in one or more panels mounted thereon. For example, a door sill may comprise a pair of tracks. The weight of a pair of panels may rest primarily the pair of coupled tracks, and the motion of the panels in their respective tracks may, over time, induce a variety of shear stresses and bending moments in the door sill. These stresses and moments may twist or shear unsatisfactorily coupled door tracks apart. However, and with respect to the present invention, orthogonally inseparable tracks may better resist, if not withstand entirely, the damage that might otherwise, and over time, occur as a result of the motion of one or more panels in their courses.

A universal door frame may further comprise one or more spacers. A spacer, which may separate a first track from a second track by a distance, may slidably couple between the first track and the second track. A spacer may be inserted between tracks based upon a size, type, and/or number of panels to be installed (e.g., where a particular manufacturer of doors indicates that a particular separation is required between sliding panels). A spacer may, as described above, be orthogonally inseparable from the tracks to which it is coupled.

Continuing, and where a universal door frame comprises, as described above, a universal bi-fold door track, the track may comprise a plurality of vertical channels, each of which may receive a locking mechanism. For example, a universal bi-fold door track may comprise a sill track and/or a header track. The sill track may receive, by way of the plurality of vertical channels, a push bolt, an internal gear lock, and the like. Similarly, the header track may receive, by way of the plurality of vertical channels, a push bolt, an internal gear lock, and the like. Thus, a universal bi-fold door track may permit the installation of a variety of lock types, depending, for example, upon a lock type associated with a particular brand, size, type, and/or style of bi-fold door to be installed.

In an embodiment, the components comprising a universal door frame (e.g., one or more tracks, headers, spacers, etc.) may be manufactured using a die or casting process. For example, a universal door track may be manufactured by way of an aluminum casting process, whereby the track may comprise a single, solid, piece. Further, a universal door frame may be sold as a kit, e.g., a commercial off the shelf (“COTS”) kit. An individual may purchase a universal door frame kit that is suitable to a particular door that the individual wishes to install. The kit may be inexpensive (in comparison to a customized door frame that may be sold with the door of interest), and may include a variety or range of spacers and/or track sizes. A variety of kits may, in addition, be offered for sale, and an individual may select a kit that is appropriate to a door the individual wishes to install.

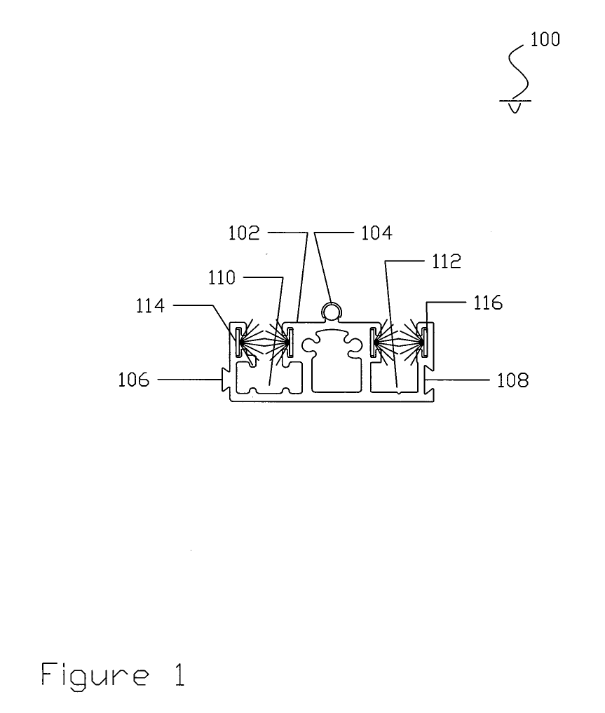

With reference now to FIG. 1, a perspective view of a track 100 is shown. As described above, a track 100 may support a door or panel (e.g., a sliding door panel). To this end, a track 100 may comprise a surface 102 and a bead 104. A surface 102 may support or lend balance and stability to a panel, and a bead 104 may support and/or guide a wheel coupled to a panel. Thus, a panel may ride on a track 100.

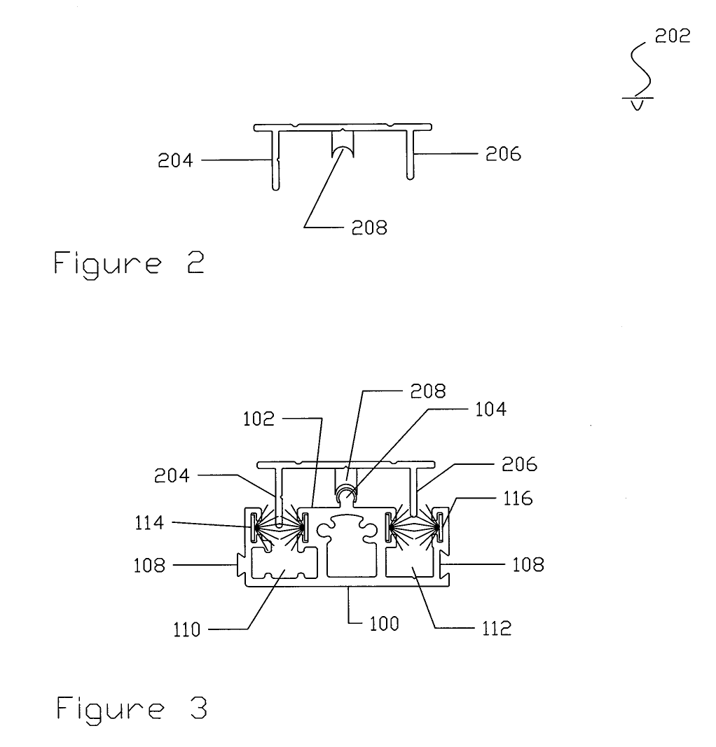

With reference to FIGS. 2 and 3, a base fitting 202 may be secured or fitted to the base of a door or panel. A base fitting may comprise one or more fins 204 and/or 206 as well as a wheel 208. Fins 204 and/or 206 may descend into one or more thermal breaks or spaces 110 and/or 112 in track 100. In an embodiment, fins 204 and/or 206 may help to insulate or shield the interior of a structure from the climate to which the door provides a barrier. Further, in an embodiment, thermal breaks 110 and/or 112 may comprise any type of thermal insulator and/or insulation. For example, a thermal break 110 and/or 112 may comprise an air or gas filled gap, fiberglass, plastic, rubber, wood, and/or any other material or combination of materials capable of providing thermal insulation. Where a thermal break 110 and/or 112 comprises a solid or semi-solid material, fins 204 and/or 206 may ride above a level of the material. That is, in an embodiment, thermal breaks 110 and/or 112 may only partially comprise a thermal insulator. As described above, wheel 208 may ride on bead 104.

A track 100 may, in addition, comprise one or more cuffs or grooves 114 and/or 116. A cuff 114 and/or 116 may be configured to receive one or more pieces or strips of weather stripping, e.g., felt, foam, tape, vinyl, door sweep, brush, and/or the like. Fins 204 and/or 206 may rub or brush against the one or more pieces or strips of weather stripping. However, in an embodiment, and as described more fully below, fins 204 and/or 206 may not rub or brush against the weather stripping.

As is also described above, a track 100 may couple to one or more other tracks. To this end, a track 100 may comprise a first interface 106 and a second interface 108, and in an embodiment, a first interface 106 may comprise a “tongue,” while a second interface 108 may comprise “groove.” A tongue may comprise a raised portion or a protrusion, while a groove may comprise an inset or a channel. In an embodiment, a tongue and groove may comprise complementary shapes. That is, a tongue may comprise a first shaped protrusion, while a groove may comprise a complementary or corresponding channel.

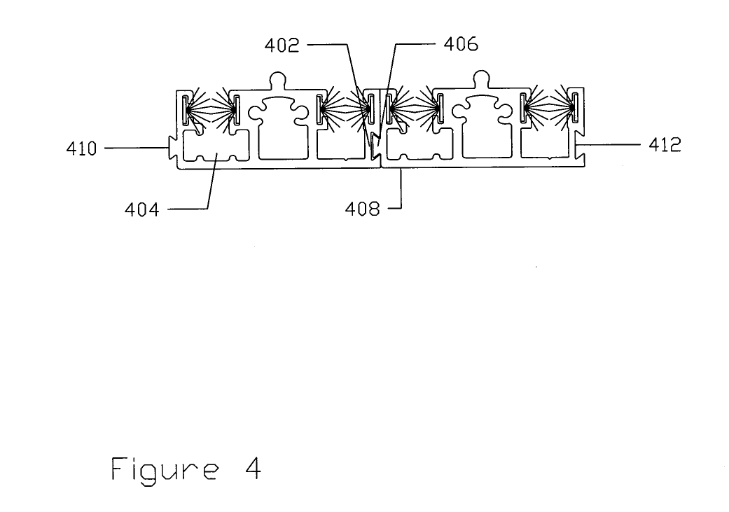

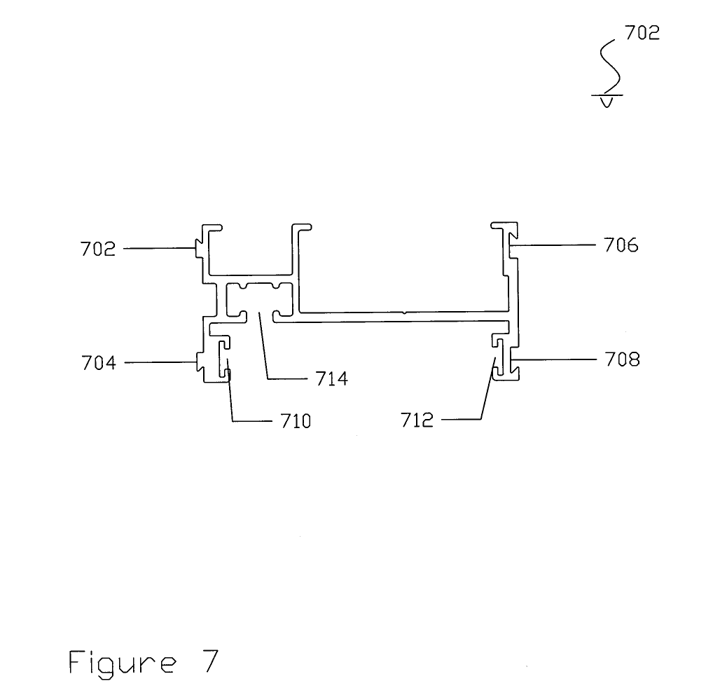

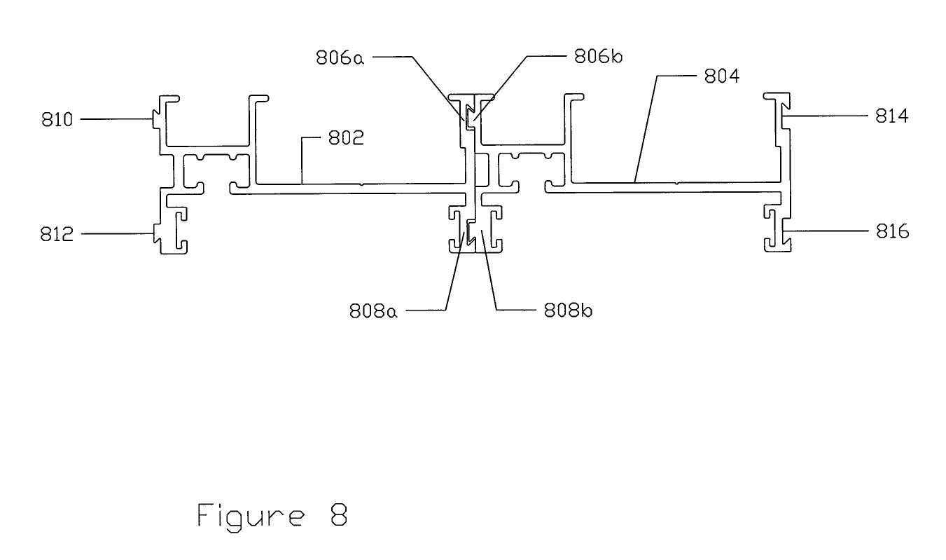

In operation, and with reference to FIG. 4, an interface 402 associated with a first track 404 may couple to an interface 406 associated with a second track 408. The coupling or connection between interface 402 and interface 406 may comprise an orthogonally inseparable connection. That is, interface 402 may slidably couple to and decouple from interface 406 along a first axis (e.g., an axis that runs parallel to the motion of a sliding door or sliding door panel), but may be orthogonally inseparable from interface 406 along any other axis. This orthogonal inseparability may depend upon the shapes of interfaces 402 and 406. Specifically, orthogonal inseparability may be achieved by manufacturing interfaces 402 and 406 such that they are only capable of freely coupling and decoupling in a single direction or along a single axis. This, in turn, may be achieved, and for example, by manufacturing interfaces 402 and 406 as interlocking joints, or interlocking joint pairs. Illustrative interlocking joint pairs comprise joints having dovetail, ball and socket, iron shaped, shoe shaped, and/or other complementary shapes. Further, although the depicted embodiment may disclose a single pair of interlocking joints (i.e., a single tongue and groove), the present disclosure generally contemplates greater numbers of interlocking joints (e.g., as described below with reference to FIGS. 7 and 8).

Thus, a track 404 may couple to and decouple from a second track 408 along a first axis but maintain a locked or orthogonally inseparable relationship with the second track 408 along any other axis. As described above, this arrangement of tracks may better resist, if not withstand entirely, the damage that might otherwise, and over time, occur as a result of the motion of one or more doors in their courses.

Commonly, multiple sliding door panels are separated by a variety of distances, depending upon, for example, the size, type, and/or number of panels to be installed. For instance, a particular manufacturer of sliding doors may specify that each panel in a set of sliding panels should be separated by a particular distance (e.g., one inch). The manufacturer may offer for sale a frame comprising a track, or a plurality of tracks, which are spaced as appropriate to the particular door. Where a manufacturer offers for sale a variety of doors in a variety of types, sizes, shapes, etc., the manufacturer may correspondingly offer for sale a frame associated with each door.

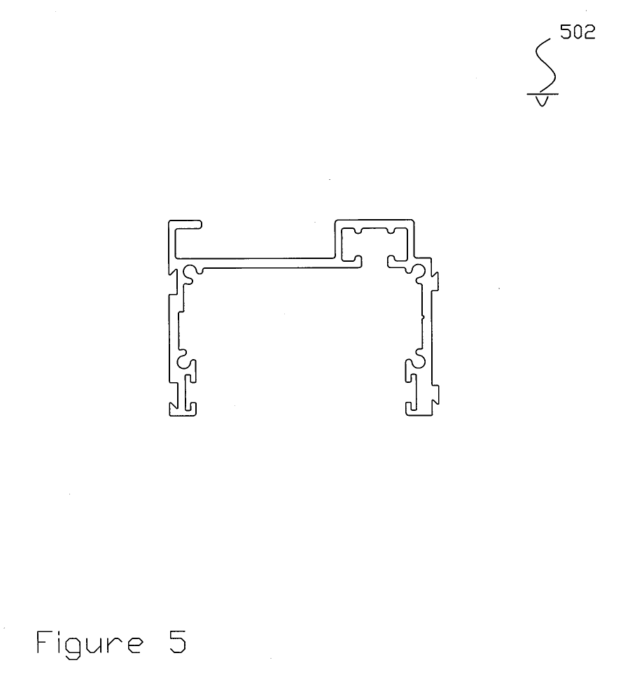

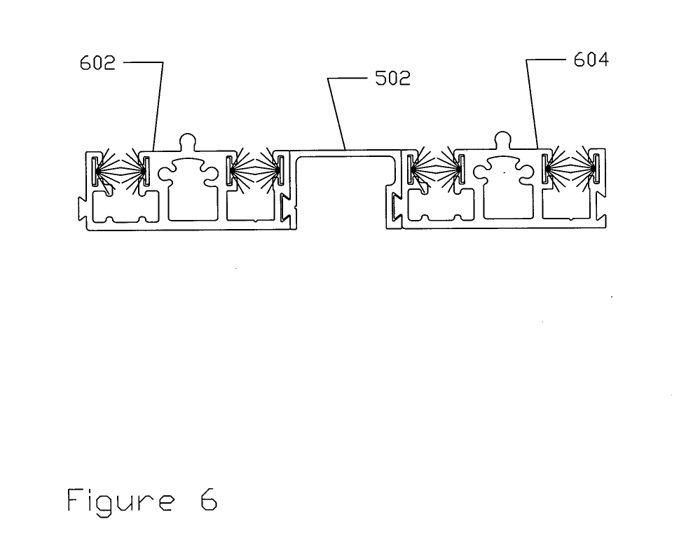

The universal door frame of the present invention may provide an alternative to the customized frames supplied by these door manufacturers. For example, and with reference to FIGS. 5 and 6, a universal door frame may comprise one or more spacers 502. A spacer 502 may slidably couple to one or more tracks 602 and/or 604. A spacer may be orthogonally inseparable, as well, from one or more tracks 602 and/or 604. Indeed, a spacer 502 may couple to tracks 602 and/or 604 as described above with reference to FIG. 4. Thus, a spacer 502 may separate tracks 602 and 604 by a distance sufficient to install a particular brand, type, style, and/or size of sliding door. Thus, a spacer 502 may be used to adjust a distance between one or more tracks (e.g. tracks 602 and 604), so that the tracks may accommodate or support a plurality of variously designed and/or manufactured doors.

With reference now to FIG. 7, a universal door frame may comprise one or more headers 702. A header 702 may bear a one-to-one relationship with a track (e.g., with brief reference to FIG. 4, each track 404 and 408 may be paired with a header). A header 702 may be mounted, as part of a universal door frame, in an upper or topmost portion of a door frame. From this position, a header 702 may receive and/or guide an upper or topmost portion of a door. As described above with reference to tracks 404 and 408, one or more headers may be slidably coupled and/or orthogonally inseparable. This may be achieved by way of one or more interfaces 702, 704, 706, and/or 708. In an embodiment, interfaces 702 and 704 may comprise tongues (see above), while interfaces 706 and 708 may comprise grooves (see above).

Thus, for example, and with reference to FIG. 8, a plurality of headers 802 and 804 may slidably couple by way of one or more interfaces 806a and 806b and 808a and 808b. That is, tongues 806b and 808b may slidably couple with grooves 806a and 808a, respectively. Further, although here, two tongues and two grooves are described, a greater or fewer number of tongues and grooves are contemplated by, and within the scope of, the present disclosure.

With continuing reference to FIG. 7, a header 702 may, like a track, comprise one or more cuffs or grooves 710 and/or 712 configured to receive one or more pieces or strips of weather stripping (as described above). Further still, a header 702 may comprise one or more thermal breaks 714, and these may operate as described above as well.

In an embodiment, a plurality of headers may be separated, again, as described above (see discussion surrounding FIGS. 5 and 6) by one or more spacers. A spacer may operate in a header configuration in the same manner that a spacer 502 operates in a track configuration to separate tracks 602 and 604. That is, a spacer may be placed between a pair of headers (e.g., headers 802 and 804) in order to adjust a distance between the headers. The distance may be adjusted, as described above, to accommodate a variety of door brands, types, styles, and/or sizes. Typically, where spacers are employed, a spacer 502 in a track may be of a same or a substantially similar width as a spacer in a header. That is, it may be important that a spacer 502 in a door sill separates a pair of panels by a same distance as a spacer in a door header separates the panels (e.g., to avoid improper installation of the panels).

With respect to installation, a universal door frame may attach to a bare door frame (e.g., to drywall) by way of one or more mounting anchors or mounting brackets. Each mounting anchor may be embedded in or coupled to a bare door frame by any suitable manner. For example, a mounting anchor may be coupled to a bare door frame using a dry wall screw or anchor. A mounting anchor may further comprise one or more tongue and/or groove shaped interfaces (as described above), to which one or more tracks and/or headers may couple. For example, with brief reference to FIG. 4, interface 410, if it is nearest a bare door frame, may couple to a groove in a mounting anchor. Likewise, with brief reference to FIG. 8, one or more of interfaces 810 and/or 812, again, if they are nearest a bare door frame, may couple to one or more grooves in a mounting anchor or anchors. Thus, a universal door frame may be easily and securely installed in a bare door frame by coupling one or more tracks and headers to one or more mounting anchors.

Furthermore, and as the reader may appreciate (although it is not depicted), any number of tracks may be coupled to accommodate any number of sliding panels. Likewise, any number of headers may be coupled, again, to accommodate any number of sliding panels. Thus, the universal door frame of the present invention may permit the installation of a frame of any size, which may accommodate any of a brand, type, style, size, and/or number of sliding door panel(s).

A universal door frame may, in addition, operate to receive one or more pieces of cladding. Cladding may comprise any of a variety of desirable facing or finishing materials (e.g., wood, stone, plastic, etc.) Further, cladding may be coupled to a track and/or header using one or more interfaces, as described above. For example, and with brief reference to FIG. 4, cladding may slidably couple to track 408 by way of interface 412, which may face into an interior of a structure or away from an exterior of a structure, depending upon the direction in which the track is mounted. Likewise, with brief reference to FIG. 8, cladding may slidably couple to header 804 by way of one or more of interfaces 814 and/or 816. Here, again, cladding may face into an interior of a structure and/or away from an exterior of a structure depending upon the direction in which the header is mounted. Thus, a universal door frame may be fitted with a variety of cladding for aesthetic as well as other purposes.

In addition to the benefits and advantages described above, a universal door frame may facilitate the installation and operation of lift and slide (or lift-slide) door systems as well. Lift and slide door systems may comprise sliding door systems (e.g., door systems comprising a plurality of sliding doors) configured to lift a plurality of doors or panels off of their respective sills or tracks during operation. As a door or panel is raised above its track, the panel may slide or roll more easily along the track.

A universal door frame may be installed as part of a lift and slide door system very much as described above. For example, a universal door frame may accommodate a variety of brands, types, styles, and/or sizes of lift and slide door panels. This may be accomplished, again, as described above, using a plurality of tracks, headers, and/or spacers, each of which may slidably couple and decouple along a single axis. Each track, header, and/or spacer may further couple in an orthogonally inseparable manner (as described above).

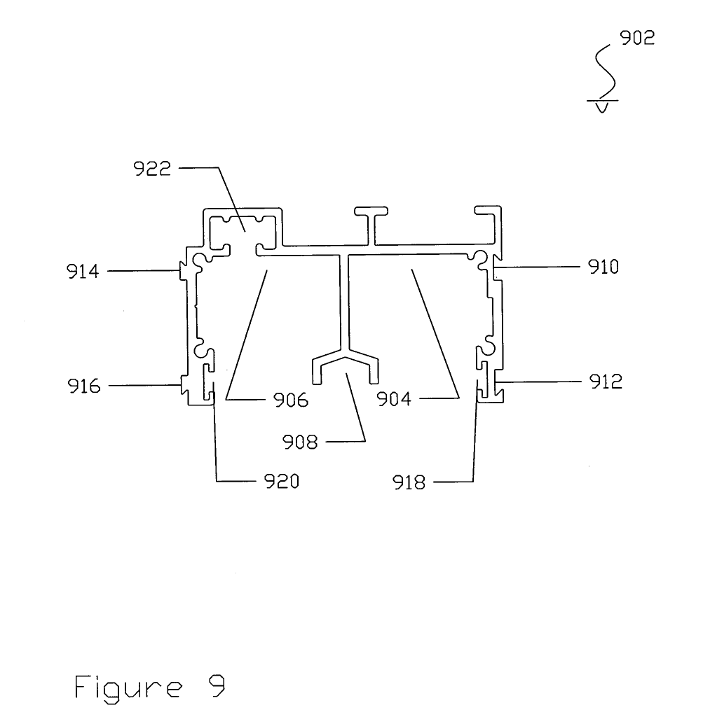

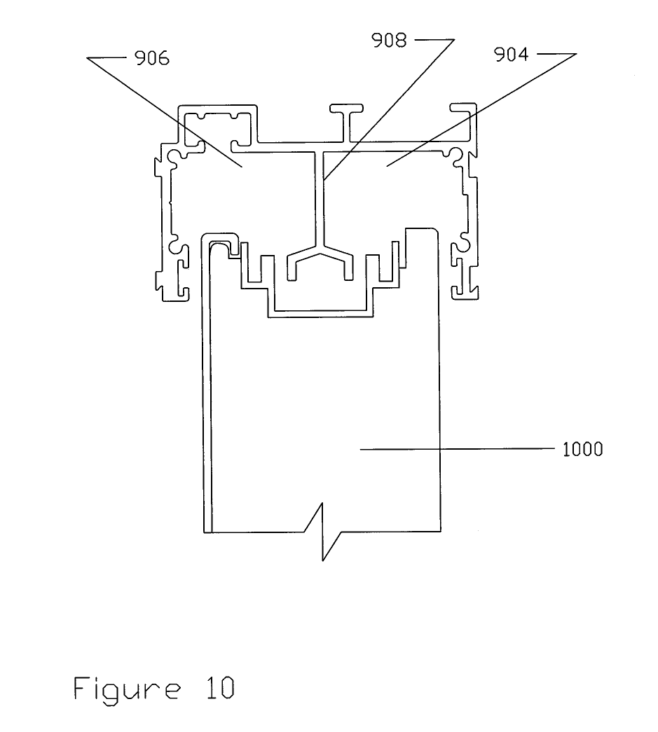

Although a roller or carriage for a lift and slide door system may vary substantially from a roller or carriage for a non-lift-and-slide system, a lift and slide system may nevertheless ride on a plurality of tracks similar to those described with respect to FIGS. 1-6. However, and with reference now to FIGS. 9 and 10, a header 902 for a lift and slide door system may vary somewhat from the headers described in FIGS. 7 and 8, which may accommodate a non-lift-and-slide set of panels. For example, a lift and slide header 902 may comprise sleeves or channels 904 and/or 906, into which an upper portion of a lift and slide panel may be raised (e.g., as the panel is raised to accommodate motion). Channels 904 and 906 may be separated by a partition 908, which may descend into a panel 1000 for guidance and stability, and as depicted at FIG. 10. That is, as a panel 1000 is raised off of its track, the channels 904 and 906 may move into place around partition 908, which, again, may stabilize and guide panel 1000.

With further regard to header 902, the header 902 may comprise, for example as described above with reference to FIG. 7, one or more interfaces 910, 912, 914, and/or 916. Interfaces 910 and 912 may comprise grooves, while interfaces 914 and 916 may comprise tongues (see above). Further, although four interfaces are depicted at FIG. 9, a lift and slide header may comprise a greater or lesser number of interfaces. Further still, and as described above, header 902 may comprise one or more cuffs or grooves 918 and/or 920, which may be configured to receive one or more pieces or strips of weather stripping (as described above). Further still, a header 902 may comprise one or more thermal breaks 922, and these may operate as described above as well.

A universal door frame may further operate in a lift and slide system to seal a header 902 and/or a track 100 against the elements. In this regard, a universal door frame may operate such that friction between the weather stripping and each door panel is reduced when the panel is in a raised position. For instance, in an embodiment, weather stripping may be applied at the base of a panel or track. Thus, when a panel is in a raised position, the panel may not contact the weather stripping, which may free the panel to move with greater ease. Likewise, when a panel is in a lowered position, the panel may come into contact with the weather stripping, which may compress and seal the weather stripping against the panel surface. In addition, and again, when a panel is in a lowered position, a panel header may come into contact with one or more pieces or strips of weather stripping. Contact between a panel and weather stripping in a header may seal an upper portion of a universal door frame against the elements as well.

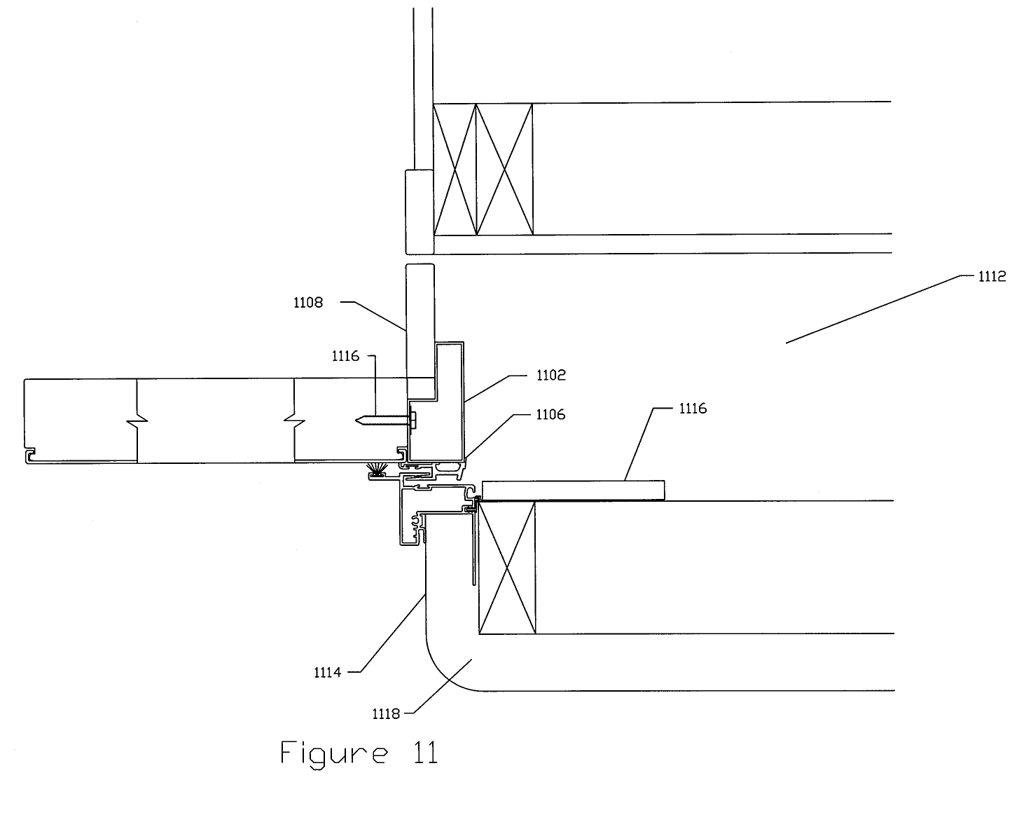

A universal door frame may, in an embodiment and as described briefly above, offer enhanced security features. For example, and with reference to FIG. 11, a universal door frame may comprise a follower 1102, which may couple to a door panel 1104. In various embodiments, follower 1102 may couple to an edge of a door panel by way of a suitable fastener or fasteners, such as one or more nuts and/or bolts, one or more screws 1116, adhesive and/or the like. Follower 1102 may further couple to an interlock 1106. In various embodiments, follower 1102 may couple to interlock 1106 by way of one a suitable fastener or fasteners, such as one or more nuts and/or bolts, one or more screws, an adhesive, and/or the like. In various embodiments, a universal door frame may further comprise a skirt board 1108 and/or a sheathing board 1110. A skirt board 1108 may mask a pocket 1112 within which one or more panels 1104 may be stored (e.g., when a universal sliding door is in a closed or a partially closed position). A sheathing board 1110 may mask all or a portion of an internal structure (e.g., the framing) of a building to which a universal door frame is mounted. A universal door frame may further comprise a post-interlock 1114, which may be coupled to an exterior portion of a structure and overlaid by a facing 1118, such as stucco, brick, paneling, and the like. Thus, a post-interlock 1114 may be inaccessible from an exterior portion of a structure.

In operation, as a panel 1104 slides into and out of pocket 1112, interlock 1106 may couple to and decouple from a post-interlock 1114. More particularly, as a panel 1104 slides out of pocket 1112, interlock 1106 may couple to post-interlock 1114. In various embodiments, an interlock 1106 may couple to a post-interlock 1114 by way of a clip or clipping mechanism, such as, for example, a pair of serrated or ridged tongues that slidably couple to and decouple from one another. Interlock 1106 may also couple do and decouple from post-interlock 1114 by way of a snap or snapping mechanism, a spring loaded or pressure fitted coupling mechanism, and/or any other mechanism that suitably permits interlock 1106 to slidably couple to and decouple from post-interlock 1114.

With regard to the enhanced security features afforded by follower 1102, the follower 1102 may be removable, by way of a screw 1116, for example, from an edge of a door panel 1104, and this may permit a sliding door system to be removed for maintenance, etc. However, in an embodiment, a follower 1102 may only be removed or decoupled from an interior of a structure to which a universal door frame is secured. That is, a follower 1102 may not be removed or decoupled from an exterior of a structure to which a universal door frame is secured. Thus, a would be thief may not gain access to the interior of a structure to which a universal door frame is mounted by decoupling an edge 1104 of a door panel from an exterior portion of the structure as, perhaps, some prior art systems may permit. Rather, the universal door system of the present invention may only permit removal of a sliding door (or group of sliding doors) from an interior of a structure, which may deter, if not altogether thwart, efforts to gain access to the structure through panels mounted on the universal door frame.

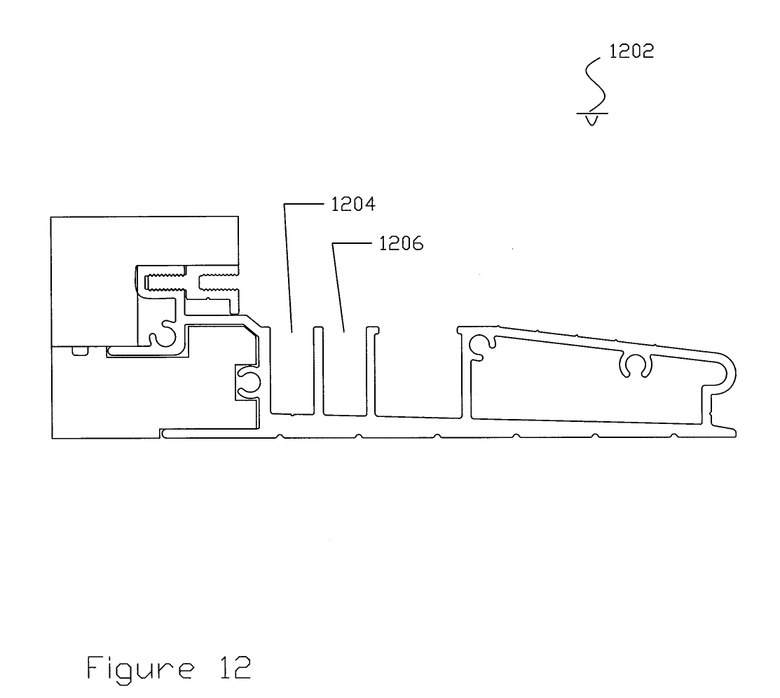

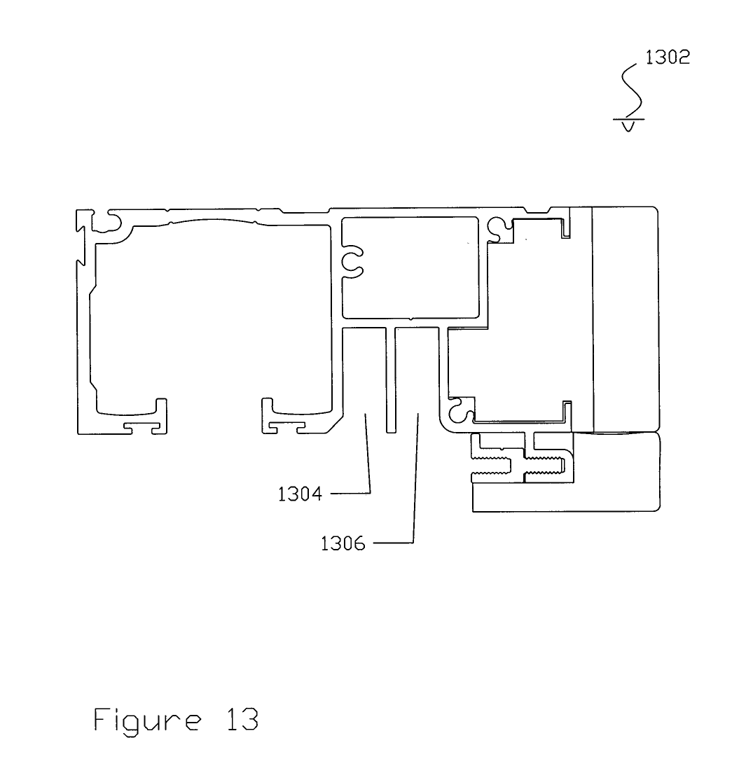

As discussed more briefly above, and with reference now to FIGS. 12 and 13, a universal door frame may accommodate a bi-fold door system (e.g., one or more bi-fold doors or panels). In this regard, a universal door frame may comprise a sill or track 1202 and a header 1302. A track 1202 may comprise a plurality of channels, each of which may be configured to receive a locking mechanism. For instance, in an embodiment, a track 1202 may comprise a first channel 1204 and a second channel 1206, each of which may receive a locking mechanism. A locking mechanism may comprise, for example, a push bolt and/or an internal gear locking mechanism. A header 1302, which, again, may be mounted in an upper or topmost portion of a universal door frame, may correspond to or be paired with a track 1202, such that the track 1202 and header 1302 are in line when a universal bi-fold door frame is installed. Like track 1202, a header 1302 may comprise a plurality of channels, each of which may receive a locking mechanism. For instance, in an embodiment, header 1302 may comprise a first channel 1304 and a second channel 1306, each of which may receive a locking mechanism.

Thus, in operation, a universal door frame may accommodate a variety of brands, types, styles, sizes, and/or numbers of bi-fold doors. For example, a universal door frame may accommodate a first bi-fold door system employing a push bolt locking mechanism as well as a second bi-fold door system employing an internal gear locking mechanism. A purchaser of a universal bi-fold door frame may therefore install a variety of types of bi-fold doors without regard to the limitations of the universal door frame. That is, a purchaser may be confident that a universal bi-fold frame will accommodate any type (or most types) of bi-fold doors.

As described more generally above, a universal door frame component (e.g., a track, a header, a spacer, etc.) may be manufactured by way of a casting process. In an embodiment, for example, a universal door frame component may comprise a cast aluminum component. One or more dies or molds may be employed in the manufacture of each component. For instance, a variety of track and/or header and/or spacer types, sizes, etc. may be manufactured using one or more dies.

Further, because a universal door frame may comprise a variety of components of varying dimensions, a universal door frame may be sold as a kit, or a COTS component. For example, a universal door frame may be sold as a mix and match kit, in which an individual selects each component from a list of available components in order to construct a desired door frame. In another example, an individual may simply purchase a pre-allocated or pre-selected group of universal door frame components. An individual may select a kit comprising these components based upon, for example, the individual's needs.

Thus, a universal door frame may permit the installation of a variety of sliding, lift and slide, and bi-fold doors, to name but a few types of doors/door systems. Moreover, a universal door frame may permit the installation of a variety of doors/door systems in an inexpensive and reliable fashion. That is, for example, one or more components may be swapped with one or more other components by way of the complementary tongue in groove interfaces discussed above. Because the components comprising a universal door frame may be made fungible, a cost associated with the installation and/or construction of a desired universal door frame may be reduced. Further, the tongue in groove interfaces employed by the universal door frames discussed herein may add strength and reliability to the door systems in which they are incorporated.

What is claimed is:

1. A universal sliding door frame comprising:
a first track having a first interface; and
a second track having a second interface that slidably couples to the first interface and is orthogonally inseparable from the first interface.

2. The frame of claim 1, further comprising a spacer that slidably couples to the first track via the first interface and the second track via the second interface and is orthogonally inseparable from the first track and the second track.

3. The frame of claim 1, wherein the first interface comprises a groove and the second interface comprises a tongue.

4. The frame of claim 1, further comprising a follower that secures an interior portion of a door to an interior portion of a structure.

5. The frame of claim 1, further comprising a sill that includes an insulating material, wherein the insulating material is compressed by the weight of a door mounted on the frame when the door is lowered within the frame.

6. The frame of claim 1, further comprising a thermal break.

7. A universal bi-fold door frame comprising
a first channel for receiving a first lock; and
a second channel for receiving a second lock.

8. The frame of claim 7, wherein at least one of: the first lock comprises a push bolt and the second lock comprises an internal gear lock.

9. The frame of claim 7, wherein the first channel and the second channel comprise at least one of a track and a header.

10. A die set for casting a universal sliding door frame comprising:
a first die for casting a first track having a first interface; and
a second die for casting a second track having a second interface that slidably couples to the first interface and is orthogonally inseparable from the first interface.

11. The die set of claim 10, further comprising a third die for casting a spacer that slidably couples to the first track via the first interface and the second track via the second interface and is orthogonally inseparable from the first track and the second track.

12. The die set of claim 10, wherein the first interface comprises a groove and the second interface comprises a tongue.

13. The die set of claim 10, further comprising a third die for casting a sill that includes an insulating material, wherein the insulating material is compressed by the weight of a door mounted on the frame when the door is lowered within the frame.

14. The die set of claim 10, wherein at least one of the first die casts a thermal break in the first track and the second die casts a thermal break in the second track.

15. A universal sliding door frame kit comprising:
a first track having a first track interface; and
a second track having a second track interface that slidably couples to the first track interface and is orthogonally inseparable from the first track interface;
a first header having a first header interface; and
a second header having a second header interface that slidably couples to the first header interface and is orthogonally inseparable from the first header interface.

16. The kit of claim 15, further comprising a track spacer that slidably couples to the first track via the first track interface and the second track via the second track interface and is orthogonally inseparable from the first track and the second track.

17. The kit of claim 15, further comprising a header spacer that slidably couples to the first header via the first header interface and the second header via the second header interface and is orthogonally inseparable from the first header and the second header.

18. The kit of claim 15, wherein the first track interface and the first header interface comprise grooves and the second track interface and the second header interface comprise tongues.

19. The kit of claim 15, wherein the first track and the second track include an insulating material that is compressed by the weight of a door when the door is lowered on the first track and the second track.

20. The kit of claim 15, wherein at least one of the first track, second track, first header, and second header comprises a thermal break.
